(19) United States
(12) Patent Application Publication
(10) Pub. No.: US 2021/0003265 A1
(43) Pub. Date: Jan. 7, 2021

(54) Vehicular Laser Lamp

(71) Applicant: Hossein Alisafaee, Terre Haute, IN (US)

(72) Inventor: Hossein Alisafaee, Terre Haute, IN (US)

(21) Appl. No.: 16/918,864

(22) Filed: Jul. 1, 2020

Related U.S. Application Data
(60) Provisional application No. 62/870,034, filed on Jul. 2, 2019.

(51) Int. Cl. F21S 45/70; F21S 41/16; F21S 41/176; F21S 41/20; F21S 41/30; F21S 41/60

(52) U.S. Cl. CPC F21S 45/70; F21S 41/16; F21S 41/60; F21S 41/285; F21S 41/30; F21S 41/176

(57) ABSTRACT

A vehicular laser lamp that utilizes a coherent light and a beam shaping element configured to produce a standard illumination pattern. The beam shaping element may be segmented to provide multiple standard illumination patterns. Alternatively, the beam shaping element may be electrically addressable like a spatial light modulator to achieve standard illumination patterns or a desired dynamic illumination pattern. The beam shaping element may also provide a curved path for an illumination pattern. A plurality of dark zones may be produced in the illumination pattern using an active beam shaping element controlled by an electronic signal.

### CROSS-REFERENCE TO RELATED APPLICATIONS

The present patent application claims the priority benefit under 35 U.S.C. § 119 of U.S. Provisional Patent Application No. 62/870,034, filed on Jul. 2, 2019, and entitled “Vehicular Laser Lamp”, the contents of which are incorporated in full be reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### PRIOR DISCLOSURES

Not Applicable.

### TECHNICAL FIELD

The present disclosure relates to the field of lighting. More specifically the disclosure is related to the lighting devices adapted for transportation.

### BACKGROUND ART

Lighting devices for transportation include vehicular lamps, such as headlamps, tail lamps, signal lamps, and stop lamps that may comprise of light-emitting diodes (LEDs) as the light source of illumination. The headlamps are generally used for driving and passing, which are also referred to high beam and low beam of the vehicle, respectively. The source of illumination generates light which later is shaped properly using reflective or refractive optical components for road illumination according to federal or government rules and regulations. The color of light for forward lighting in headlamps is usually white, while for tail or stop lights, the color is red. Some signal lamps are made with light sources having an amber color as well.

Alternative light sources have been considered for enhanced visibility in forward lighting. One of the recent approaches for enhanced visibility is the use of lasers for the light source. In such devices, usually, a blue laser is used to create white light after conversion by a wavelength converting phosphor. The generated white light is then used as the source of light for forward lighting. A particular problem with such headlight is that upon a malefaction of the phosphor, the laser light may be delivered directly to the outside world which could cause safety concerns according to laser safety standards and guidelines.

It is then desired to have safer solutions for the design of a laser-based headlamp.

To the present day, laser lighting has been used for high beam in the cars. BMW i8 is an example for providing such auxiliary high beams. However, there is no design of laser lighting for low beams. The reason may be due to safety facts or even due to the reason that low beam illumination patterns are comparatively much more complex and difficult to design. Therefore, it is desired to find a method for creating low beam patterns using laser light sources.

The conventional methods of shaping illumination patterns for automotive lighting involve the use of elliptical or concave reflectors. To emit sufficient amount of light into the illumination pattern, elliptical reflectors must capture a majority of generated light which is emitted into a large solid angle of emission for typical light sources. For LEDs, the emission pattern is Lambertian having a cone half-angle of 60 degree at which the intensity reduced to 50% of maximum at 0 degree. Therefore, to achieve capturing most of the available light, the reflectors must be designed considerably larger than the light source. A complex manufacturing process is also used to mold the reflectors out of plastic material and then coat them with reflective materials such as aluminum.

A more recent method of shaping the illumination pattern comprises of using lightguides as a method of optical beam re-orienting (e.g. U.S. Pat. No. 16,435,535 by the current inventor).

All types of automotive lamps use plastics for volume production. There are known environmental issues with the use of plastics and countries around the world have been trying to reduce the usage of products based on plastics. Automotive lamps are no different. The number of vehicles on the road is far too much and considering the huge amount of plastic that can be saved by reducing the usage of this material in the vehicular lamps is significant.

Yet another problem with plastic parts is the issues before production. The plastic part design is a limited method and there are rules for obtaining desired parts in production. Among the design rules for part design, the thinness of part is of critical importance since a thick part will end up suffering from sinked surfaces. When it comes to optical components such as reflectors or lenses, such sinks are major factors for malfunctioning of the lamp due to increased reflection or refraction of light onto undesirable points, and vice versa. For this reason, sometimes the optical parts undergo several iterations of pre-production for tooling corrections which is costly and very lengthy. This is a second problem with having large plastic parts.

What is desirable is a new approach for the design of vehicle lamps, with laser light sources, that is based on consumption of less plastic, as much as possible, and safe usage of lasers. The technology should be capable to address the design challenges in high beam, low beam and other vehicular lamps.

### BRIEF SUMMARY OF ONE EMBODIMENT OF THE DISCLOSURE

The various embodiments of the present disclosure may, but do not necessarily, achieve one or more of the following goals: a primary object of the present disclosure is to provide laser-based lamps for vehicles that will overcome the shortcomings of the prior art; another object is to provide an automotive lamp that generates a low beam pattern using a very thin part; another object of the present disclosure is to provide a laser-based automotive lamp with variable illumination patterns. These and other advantages may be realized by reference to the remaining portions of the specification, claims, and abstract.

The present disclosure is a laser-based lamp for vehicles. One embodiment of the disclosure comprises at least a laser light source, and at least a beam shaping element (BSE). The laser light beam is transformed and shaped by the BSE to provide a standard illumination pattern in compliance with federal rules and regulations. The BSE may be a diffractive optical element, holographic optical element, metasurface (metalens), or a combination of them.

The above description sets forth, rather broadly, a summary of one embodiment of the present disclosure so that the detailed description that follows may be better understood and contributions of the present disclosure to the art may be better appreciated. Some of the embodiments of the present disclosure may not include all of the features or characteristics listed in the above summary. There are, of course, additional features of the disclosure that will be described below and will form the subject matter of claims. In this respect, before explaining at least one embodiment of the disclosure in detail, it is to be understood that the disclosure is not limited in its application to the details of the construction and to the arrangement of the components set forth in the following description or as illustrated in the drawings. The disclosure is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

Various objects, features and attendant advantages of the present invention will become fully appreciated as the same becomes better understood when considered in conjunction with the accompanying drawings, in which reference characters designate the same or similar parts throughout the several views, and wherein:

FIG. 1 is substantially a schematic of producing a low beam illumination pattern in compliance with US Federal Regulation FMVSS 108 using laser light and a BSE.

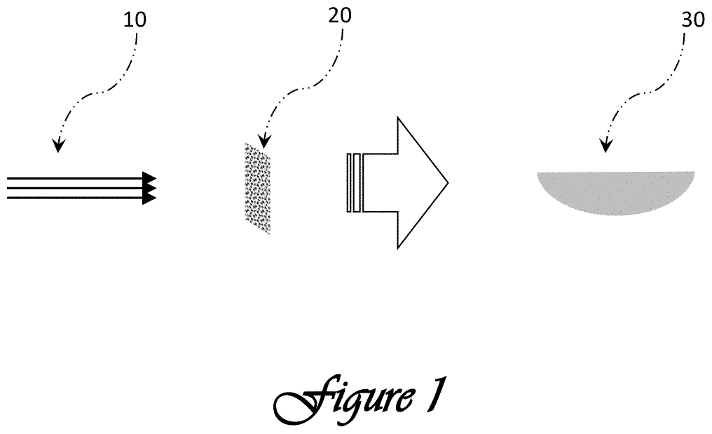

FIG. 2 is substantially a schematic of producing a low beam illumination pattern in compliance with UN/ECE Regulation using laser light and a BSE.

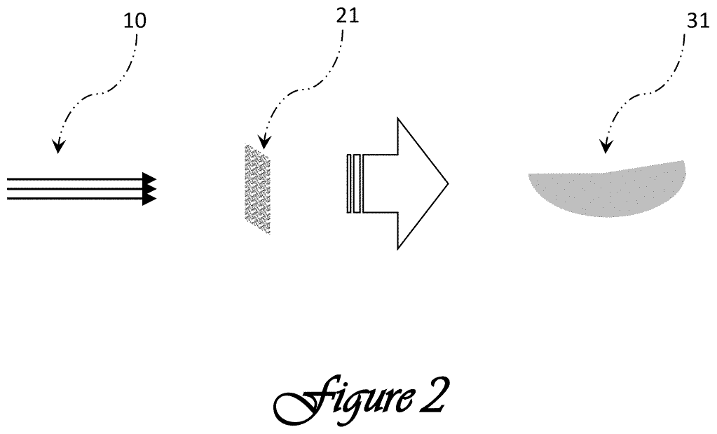

FIG. 3 is substantially a schematic of producing a low beam illumination pattern in compliance with UN/ECE Regulation using laser light and a BSE.

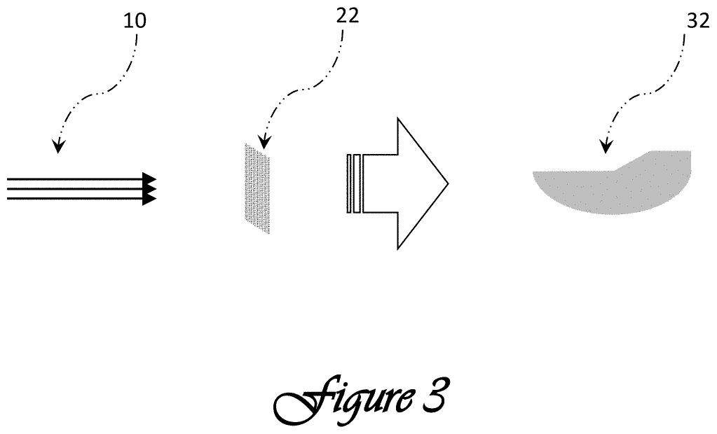

FIG. 4 is substantially a schematic of producing a high beam illumination pattern in compliance with UN/ECE Regulation or US Federal Regulation FMVSS 108 using laser light and a BSE.

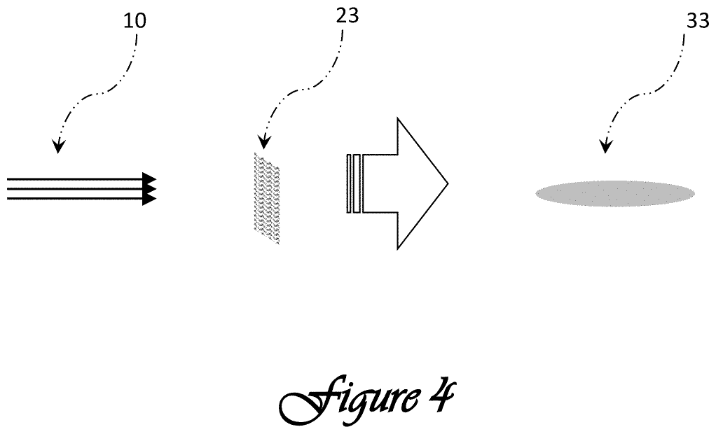

FIG. 5 is substantially a schematic of producing, selectively, any of high or low beam illumination patterns in compliance with UN/ECE Regulations or US Federal Regulation FMVSS 108 using laser light and a combination of different BSEs.

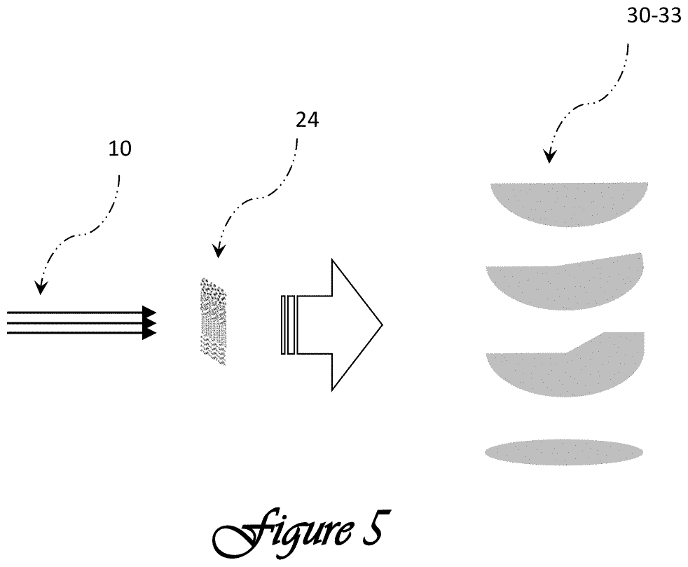

FIG. 6 is substantially a schematic of producing any of high or low beam illumination patterns in compliance with UN/ECE Regulations or US Federal Regulation FMVSS 108 using laser light and a combination of different BSEs mounted on a rotating wheel.

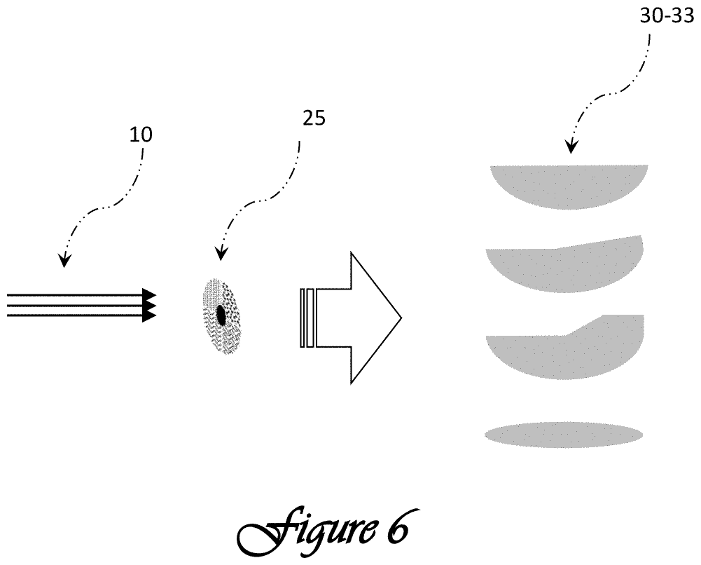

FIG. 7 is substantially a schematic of producing any of high or low beam illumination patterns in compliance with UN/ECE Regulations or US Federal Regulation FMVSS 108 using laser light and a combination of different BSEs mounted on a rotating wheel. A lens may be used for control and projection of light.

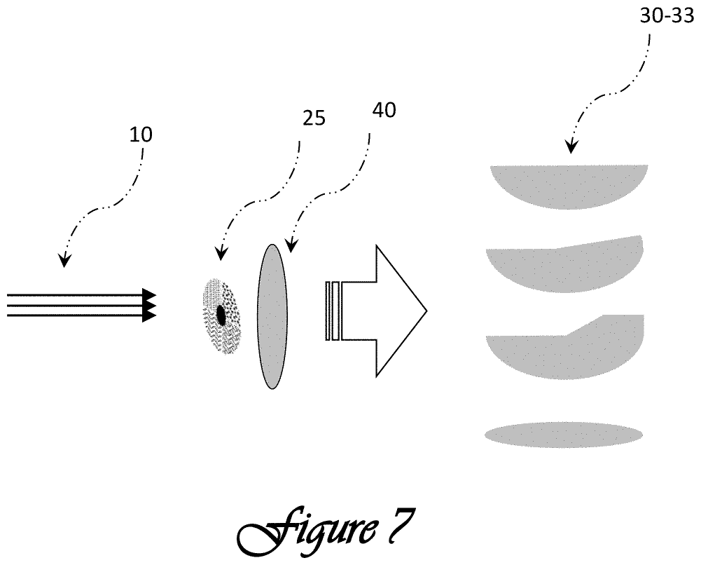

FIG. 8 is substantially a schematic of producing any of high or low beam illumination patterns in compliance with UN/ECE Regulations or US Federal Regulation FMVSS 108 using laser light and a combination of different BSEs mounted on a rotating wheel. Two lenses may be used for control and projection of light.

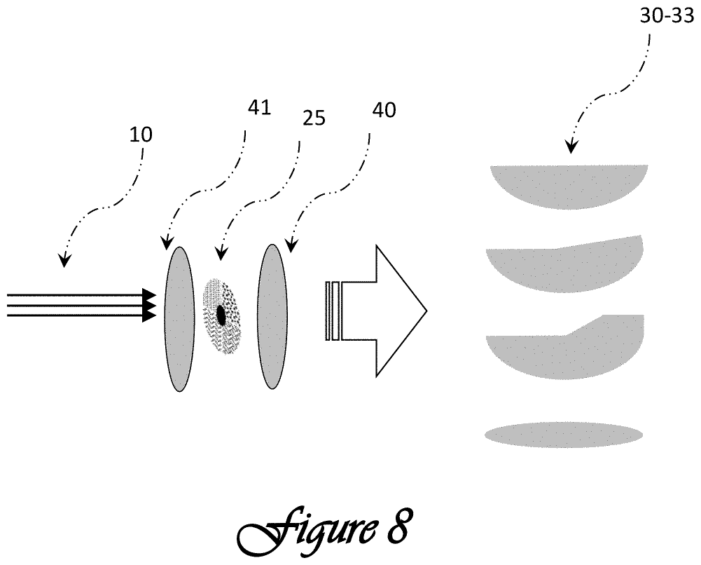

FIG. 9 is substantially a schematic of producing any of high or low beam illumination patterns in compliance with UN/ECE Regulations or US Federal Regulation FMVSS 108 using laser light and a transmissive spatial light modulator. A lens may be used for control and projection of light.

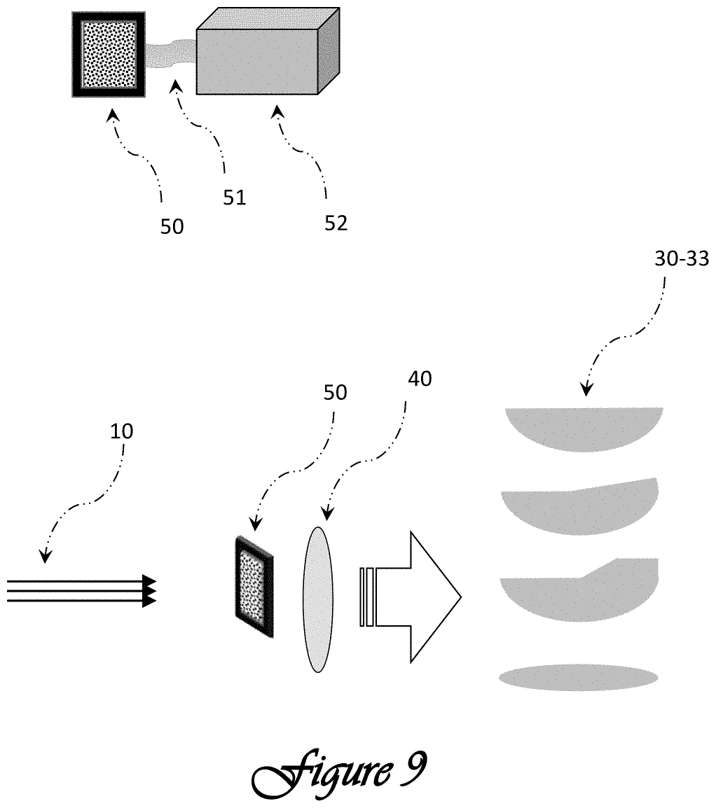

FIG. 10 is substantially a schematic of producing any of high or low beam illumination patterns in compliance with UN/ECE Regulations or US Federal Regulation FMVSS 108 using laser light and a reflective spatial light modulator (SLM). A lens may be used for control and projection of light.

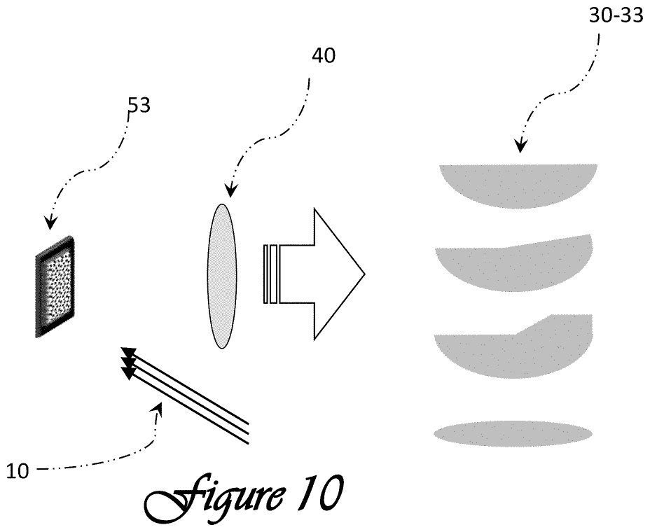

FIG. 11 is substantially a schematic of producing any of high or low beam illumination patterns in compliance with UN/ECE Regulations or US Federal Regulation FMVSS 108 using laser light and a reflective spatial light modulator (SLM). A lens may be used for control and projection of light. The laser light may be incident at an angle from below of SLM.

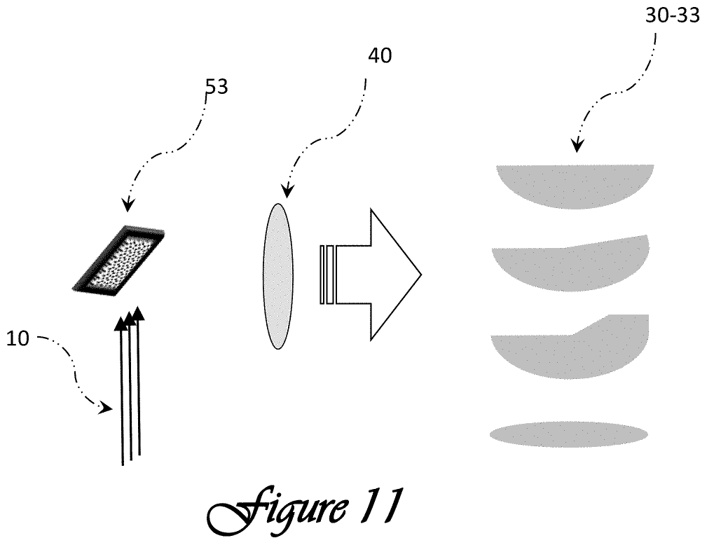

FIG. 12 is substantially a schematic of producing any of high or low beam illumination patterns in compliance with UN/ECE Regulations or US Federal Regulation FMVSS 108 using laser light and a reflective spatial light modulator (SLM). A lens may be used for control and projection of light. The laser light may be incident at an angle from above of SLM.

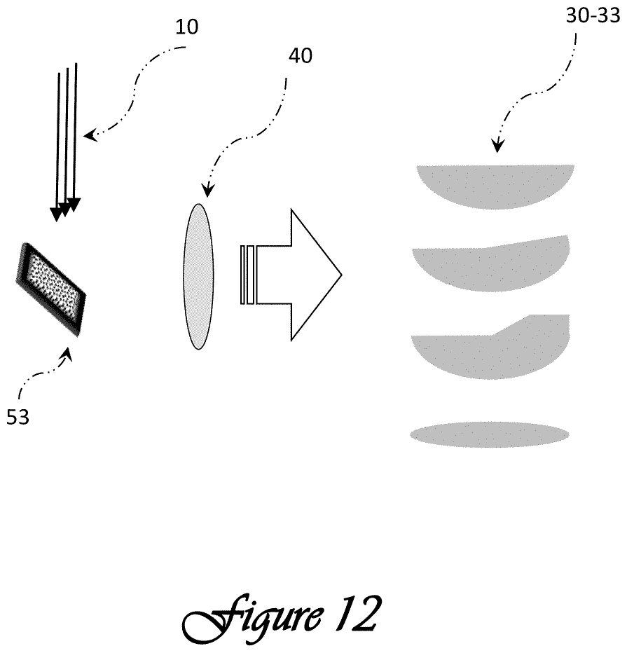

FIG. 13 is substantially a schematic of producing any of high or low beam illumination patterns in compliance with UN/ECE Regulations or US Federal Regulation FMVSS 108 using laser light and a reflective BSE. A lens may be used for control and projection of light.

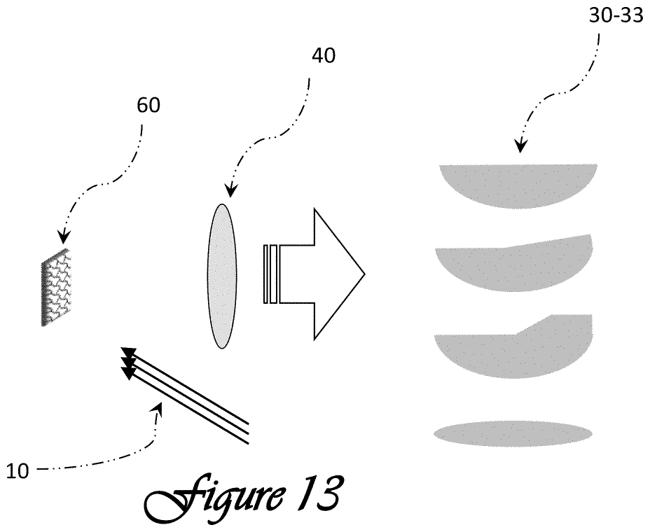

FIG. 14 is substantially a schematic of producing any of high or low beam illumination patterns in compliance with UN/ECE Regulations or US Federal Regulation FMVSS 108 using laser light and a reflective BSE. A lens may be used for control and projection of light. The laser light may be incident at an angle from below of the BSE.

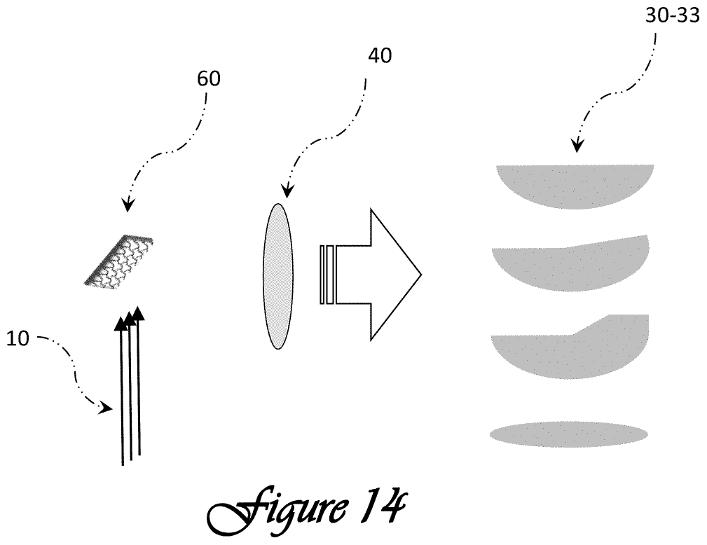

FIG. 15 is substantially a schematic of producing any of high or low beam illumination patterns in compliance with UN/ECE Regulations or US Federal Regulation FMVSS 108 using laser light and a reflective BSE. A lens may be used for control and projection of light. The laser light may be incident at an angle from above of the BSE.

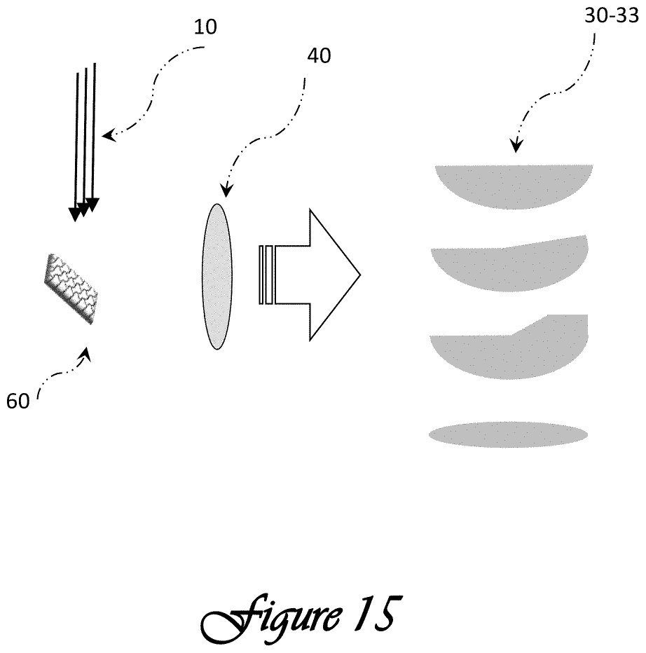

FIG. 16 is substantially a schematic of producing any of high or low beam illumination patterns in compliance with UN/ECE Regulations or US Federal Regulation FMVSS 108 using laser light and a BSE combined with a lens.

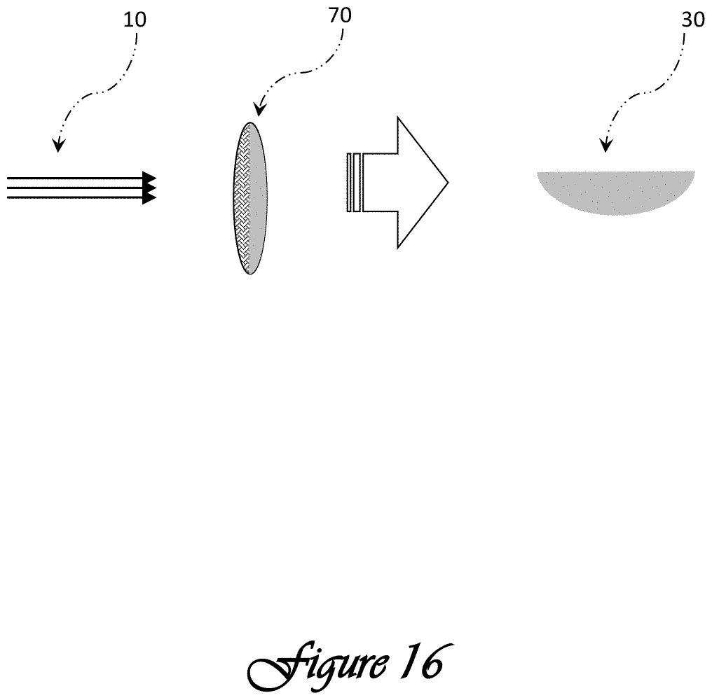

FIG. 17 is substantially a schematic of producing any of high or low beam or fog illumination pattern in compliance with UN/ECE Regulation or US Federal Regulation FMVSS 108 using laser light and a BSE. The trajectories of the light rays are bend after BSE element.

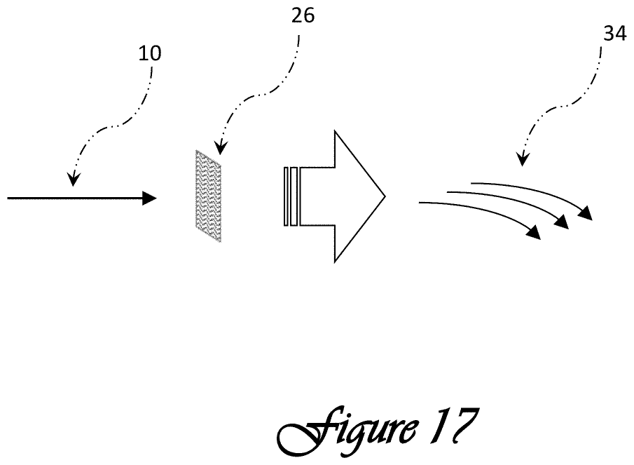

FIG. 18 is substantially a schematic of producing any of stop/tail/turn standard illumination patterns in compliance with UN/ECE Regulation or US Federal Regulation FMVSS 108 using laser light and a BSE.

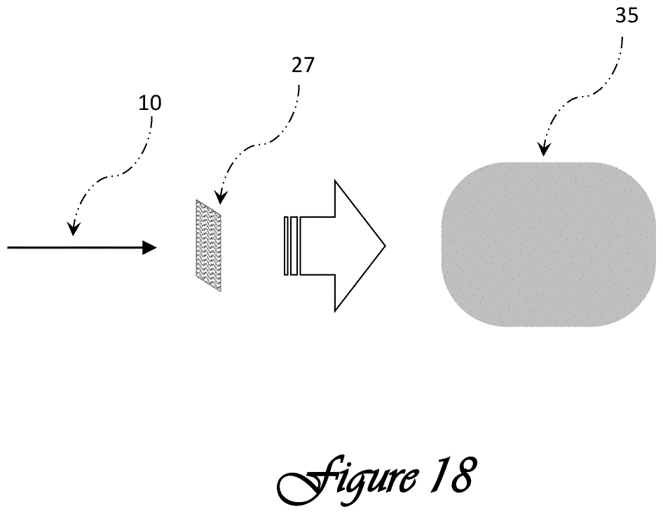

FIG. 19 is substantially a schematic of producing a high beam illumination pattern using a spatial light modulator (SLM). The SLM is able to produce and actively change dark zones at desired locations in the illumination pattern.

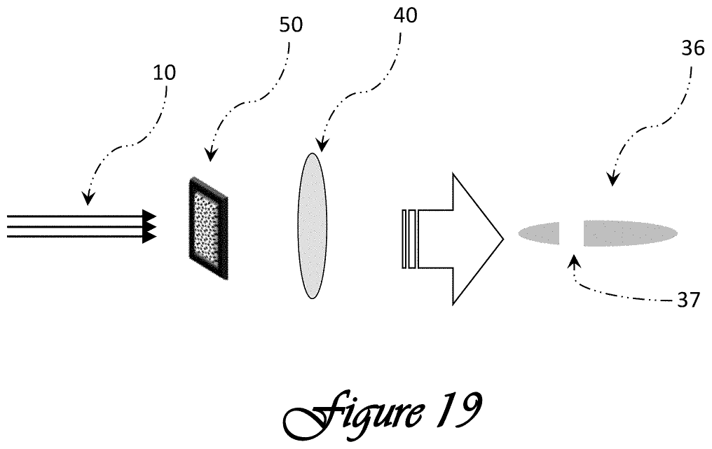

FIG. 20 is substantially a schematic of producing an illumination pattern using a BSE combined with a light-converting phosphor material.

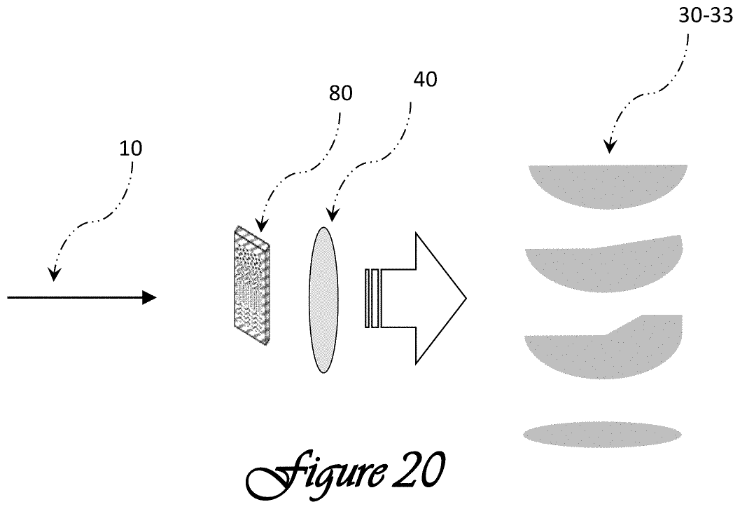

FIG. 21 substantially shows example of a low beam illumination pattern projected on a wall and the corresponding optical transfer function required to be incorporated as a phase code in a BSE for obtaining it.

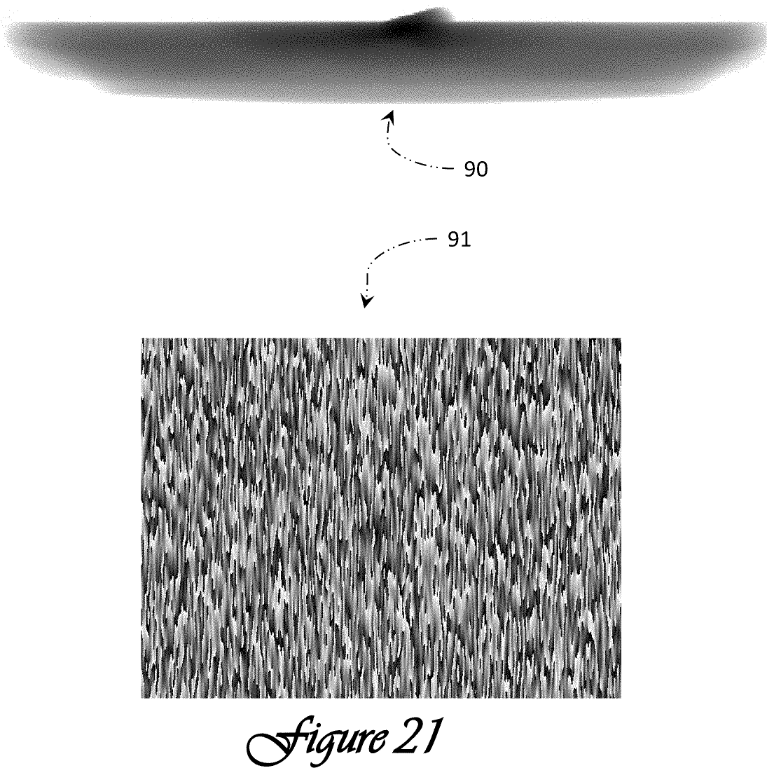

What is claimed is:

1. A vehicular laser lamp comprising:
a laser light source producing a coherent light; and,
a beam shaping element configured to receive the coherent light from the laser light source and produce an illumination pattern.

2. The lamp of claim 1, wherein said laser light is a combination of two or more laser colors.

3. The lamp of claim 1, wherein said laser light source is a pulsed source.

4. The lamp of claim 1, wherein said laser light source is a continuous wave source.

5. The lamp of claim 1, wherein said beam shaping element is disposed over a thin, clear plastic material, with a thickness being less than three millimeters.

6. The lamp of claim 1, wherein said beam shaping element is configured in a plurality of different segments, each segment produces a different illumination pattern and is placed to interact with said laser light using relative rotation or translation of said beam shaping element.

7. The lamp of claim 1, wherein said beam shaping element is a spatial light modulator, the spatial light modulator is dynamically configurable by an electric signal to produce and switch between a plurality of illumination patterns.

8. The lamp of claim 1, further comprised of a lens of focal length F placed at a distance d after said beam shaping element and before said illumination pattern, wherein F/2<d<2F.

9. The lamp of claim 1, further comprised of a lens of focal length F placed at a distance d before said beam shaping element, wherein F/2<d<2F.

10. The lamp of claim 1, wherein said beam shaping element is a reflective component.

11. The lamp of claim 1, wherein said beam shaping element is combined with a refractive lens.

12. The lamp of claim 1, wherein said beam shaping element is configured to produce a curved path for the illumination pattern.

13. The lamp of claim 1, wherein said light source is red in color and said beam shaping element is configured to produce a standard illumination pattern.

14. The lamp of claim 1, wherein said beam shaping element is a spatial light modulator, the spatial light modulator is dynamically configurable by an electric signal to produce a standard high beam illumination pattern, wherein the illumination pattern has a plurality of dark zones at a plurality of locations, the locations of dark zones are determined by the configuration of the spatial light modulator and controlled by the electric signal.

15. The lamp of claim 1, wherein said beam shaping element is disposed on one side of a light conversion material, the laser light source is substantially monochromatic, the light conversion material illuminated by the laser light source produces a white color.

16. The lamp of claim 1, further comprised of an optical lens, the lens having a first curved surface and a second curved surface, wherein the beam shaping element is disposed at the first curved surface of the optical lens.

17. A method for producing a standard illumination pattern in a vehicular laser lamp comprising:
generating coherent radiation from a laser light source; and,
configuring a beam shaping element to form light into the standard illumination pattern.

18. The lamp of claim 1, wherein the beam shaping element is metalens.

19. The lamp of claim 1, wherein the beam shaping element is achromatic.

20. The lamp of claim 1, wherein the beam shaping element is apochromatic.
